(19) United States
(12) Patent Application Publication
(10) Pub. No.: US 2024/0152573 A1
(43) Pub. Date: May 9, 2024

(54) CONVOLUTION CIRCUIT AND CONVOLUTION COMPUTATION METHOD

(71) Applicant: Realtek Semiconductor Corporation, Hsinchu (TW)

(72) Inventors: Cheng Hao LEE, Hsinchu (TW); Pei Keng SUN, Hsinchu (TW)

(21) Appl. No.: 18/473,301

(22) Filed: Sep. 25, 2023

(30) Foreign Application Priority Data
Nov. 4, 2022 (TW) 111142301

(51) Int. Cl. G06F 17/15; G06F 17/16

(52) U.S. Cl. CPC G06F 17/153; G06F 17/16

(57) ABSTRACT

A convolution circuit includes a buffer memory and a computation circuit. The computation circuit receives an input element according to a memory access sequence, and determines whether a filter location corresponding to each weight of a weight matrix is within an operation range. For each weight within the operation range, the computation circuit calculates an index of the buffer memory, reads a temporary value located at the index, multiply the input element and the weight to obtain a product, and accumulate the product to the temporary value. If accumulation times of the temporary value meet a predetermined number of times, the temporary value is output. If the accumulation times do not meet the predetermined number of times, the temporary value is stored back into the buffer memory.

### RELATED APPLICATIONS

This application claims priority to Taiwan Application Serial Number 111142301 filed Nov. 4, 2022, which is herein incorporated by reference.

### BACKGROUND

### Field of Invention

The present disclosure relates to a circuit for performing convolution.

### Description of Related Art

Convolutional neural network (CNN) has been applied to many fields. When a network performs convolution, it is necessary to store two-dimensional input data in a memory, and thus a size of the memory is required to be large. How to use less memory to perform the convolution is a topic concerned by those skilled in the art.

### SUMMARY

Embodiments of the present disclosure provide a power module including a buffer memory and a computation circuit electrically connected to the buffer memory. The computation circuit is configured to receive an input element of an input matrix according to a memory access sequence. Multiple weights of a weight matrix are stored in the computation circuit. The computation circuit is also configured to determine whether a filter location corresponding to each of the weights is within an operation range according to a coordinate of the input element. For each of the weights within the operation range, the computation circuit is configured to calculate an index of the buffer memory according to the coordinate of the input element and a coordinate of a corresponding weight, read a temporary value at the index in the buffer memory, multiply the input element and the corresponding weight to obtain a product, and accumulate the product to the temporary value. If accumulation times of the temporary value meet a predetermined number of times, the computation circuit is configured to output the temporary value as an output element of an output matrix, and reset the accumulation times. If the accumulation times do not meet the predetermined number of times, the computation circuit is configured to store the temporary value back to the buffer memory.

From another aspect, embodiments of the present disclosure provide a convolution computation method for a computation circuit. The convolution computation method includes: receive an input element of an input matrix according to a memory access sequence; determining whether a filter location corresponding to each weight of a weight matrix is within an operation range according to a coordinate of the input element; for each of the weights within the operation range, calculating an index of the buffer memory according to the coordinate of the input element and a coordinate of a corresponding weight; reading a temporary value at the index in the buffer memory, multiplying the input element and the corresponding weight to obtain a product, and accumulating the product to the temporary value; if accumulation times of the temporary value meet a predetermined number of times, outputting the temporary value as an output element of an output matrix, and resetting the accumulation times; and if the accumulation times do not meet the predetermined number of times, storing the temporary value back to the buffer memory.

### BRIEF DESCRIPTION OF THE DRAWINGS

The invention can be more fully understood by reading the following detailed description of the embodiment, with reference made to the accompanying drawings as follows.

FIG. 1 is a diagram of a convolution circuit in accordance with an embodiment.

FIG. 2 is a diagram illustrating the filter locations in accordance with an embodiment.

FIG. 3 is a diagram illustrating sizes of the output matrix and the buffer memory in accordance with an embodiment.

FIG. 4 is a diagram illustrating a table 400 recording multiplication of every output element.

FIG. 5A and FIG. 5B are diagrams illustrating tables 500A and 500B respectively in accordance with an embodiment.

FIG. 6 is a diagram of the operation of the convolution circuit in the trust environment in accordance with an embodiment.

FIG. 7 is a diagram of a convolution circuit with function of encryption and decryption.

FIG. 8 is a flow chart of a convolution computation method in accordance with an embodiment.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

In the disclosure, a two-dimensional input matrix is transformed into one-dimensional data. When performing convolution, elements of the one-dimensional data is processed according to a memory access sequence for performing all required multiplications of the elements. A next element is read after processing one element which will not be used later. Therefore, the entire input matrix is not necessarily stored in a memory.

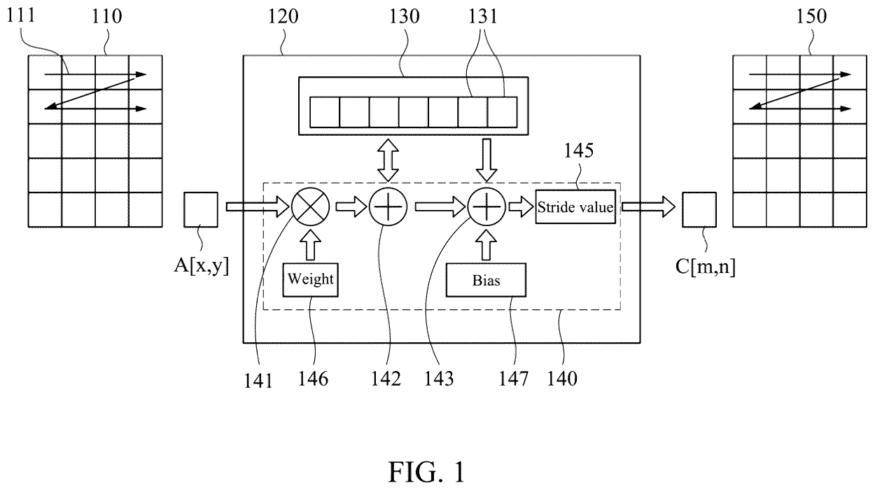

FIG. 1 is a diagram of a convolution circuit in accordance with an embodiment. Referring to FIG. 1, a convolution circuit 120 includes a buffer memory 130 and a computation circuit 140 which are electrically connected to each other. The buffer memory 130 may be a random access memory, a flash memory, etc. The buffer memory 130 stores multiple temporary values 131 which are initialized to be zeros. The computation circuit 140 is configured to perform a convolution computation method. The computation circuit 140 includes a multiplier 141, an adder 142, an adder 143, and other logic circuits (not shown). The computation circuit 140 also stores weights 146 of a weight matrix (also referred to as a filter), a bias 147, and a stride value 145. The weights 146 and the bias 147 are used to perform convolution. People in the related art should be able to appreciate the convolution which will not be described in detail herein.

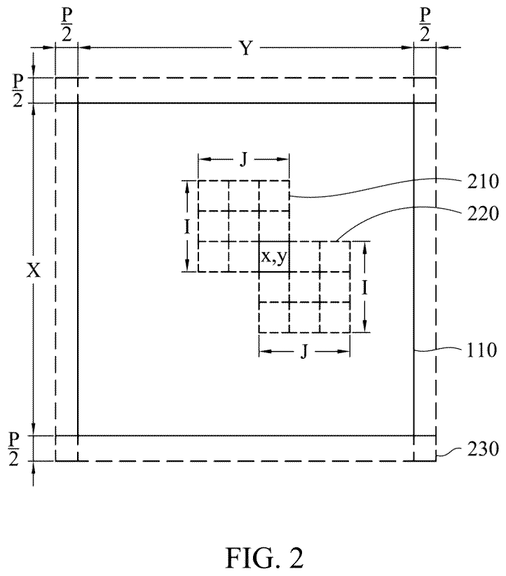

First, the computation circuit 140 receives an input element of an input matrix 110 according to a memory access sequence 111 which is from left to right (read a row of elements) and then from up to down (then read a next row of elements) as illustrated in FIG. 1. The memory access sequence 111 indicates that the elements of the input matrix 110 are read according to sequential memory addresses. When performing the convolution, the filter moves and the weights of the filter are multiplied by corresponding input elements. That is, one input element corresponds to multiple filter locations. For example, FIG. 2 is a diagram illustrating the filter locations in accordance with an embodiment. Assume the input matrix 110 is written as a matrix A whose size is X×Y, and the filter is represented as a weight matrix B whose size is I×J where X, Y, I, and J are positive integers. The positive integers I and X are also referred to as row amounts. The positive integers Y and J are also referred to as column amounts. The positive integer I is less than X, and the positive integer J is less than Y. A[x,y] represents the input element located at the coordinate (x,y) in the input matrix 110 (i.e., the element at the x^{th} row and y^{th} column). B[i,j] represents the weight located at the coordinate (i,j) in the weight matrix. In the embodiment of FIG. 2, a size of the filter is 3×3, and thus the filer includes nine weights of B[0,0], B[0,1], . . . , B[2,2]. When a center of the filter moves to the coordinate (x−1, y−1) (shown as the filter 210), the weight B[2,2] is multiplied by the input element A[x,y]. When the center of the filter moves to the coordinate (x+1,y+1) (shown as the filter 220), the weight B[0,0] is multiplied with the input element A[x,y]. However, when the input element A[x,y] locates at four edges of the input matrix 110, the filter may be out of a range of the input matrix 110. Therefore, not all weights B[i,j] will be multiplied by the input element A[x,y]. For example, when the coordinate (x,y) is equal to (0,0), the weight B[2,2] will not be multiplied by the input element A[x,y]. Accordingly, for the input element A[x,y], it should be determined whether the filter location of each weight B[i,j] is within an operation range according to the coordinate (x,y). If the input matrix 110 is not padded, the operation range is equal to the range of the input matrix 110. If the input matrix 110 is padded (e.g., P/2=1 pixel is padded in four edges in FIG. 2), then the operation range is equal to the range of the input matrix 110 plus a circular padding range 230 whose width is P/2. In other embodiments, P/2=2 pixels may be padded. The padding range 230 is symmetric in the embodiment, but the padding range may be asymmetric in other embodiment.

In detail, the coordinate (i,j) of the weight is subtracted from the coordinate (x,y) of the input element to obtain a coordinate (x−i,y−j) which is an upper left corner of the filter. Whether x−i is less than 0 and whether y−j is less than 0 can be used to determine whether a corresponding filter location is out of a first computation boundary (i.e., left boundary or upper boundary). In addition, the size (I,J) of the filter is added to the coordinate (x−i,y−j) to obtain a coordinate (x−i+l,y−j+J). Whether x-i+l is greater than the positive integer X and whether y−j+J is greater than the positive integer Y can be used to determine whether the corresponding filter location is out of a second computation boundary (i.e., right boundary or down boundary). The said determination can be written as the following Equation 1 or Equation 2 according to the way of padding.

X−I≥x+P−i≥0,i=0,1,2, . . . ,I−1,

Y−J≥y+P−j≥0,j=0,1,2, . . . ,J−1 [Equation 1]

X−I+P≥x−i≥0,i=0,1,2, . . . ,I−1

Y−J+P≥y−j≥0,j=0,1,2, . . . ,J−1 [Equation 2]

Equation 1 is for the padding used in the machine learning framework CAFFE®, and Equation 2 is for the padding used in the machine learning framework TensorFlow®. If the input matrix is not padded, the positive integer P is set to be zero. For the input element A[x,y] and every coordinate (i,j), whether Equation 1 (or Equation 2) is satisfied is determined, and the equation is satisfied, the filter location of the coordinate (i,j) is within the operation range. Note that there may be more than one filter locations within the operation range.

Referring to FIG. 1, for every weight 146 within the operation range, the multiplier 141 multiplies the input element A[x,y] by the weight 146 to obtain a product, and the product is accumulated to a corresponding temporary value 131 in the buffer memory 130. The following shows how to determine the temporary value 131. First, a coordinate of an output element is calculated. Assume an output matrix 150 is written as a matrix C whose size is M×N, where M and N are positive integers. The positive integer M is also referred to as a row amount, and the positive integer N is also referred to as a column amount, where M=X+P−I+1, N=Y+P−J+1. C[m,n] represents an output element located at a coordinate (m,n) in the output matrix 150. The coordinate (i,j) of the corresponding weight is subtracted from the coordinate (x,y) of the input element to obtain a coordinate (m,n) of the output element. For different ways of padding, the coordinate (m,n) is calculated as the following Equation 3 or Equation 4.

m=x−i+P

n=y−j+P [Equation 3]

m=x−i

n=y−j [Equation 4]

Equation 3 is for the padding used in the machine learning framework CAFFE®, and Equation 4 is for the padding used in the machine learning framework TensorFlow® or no padding.

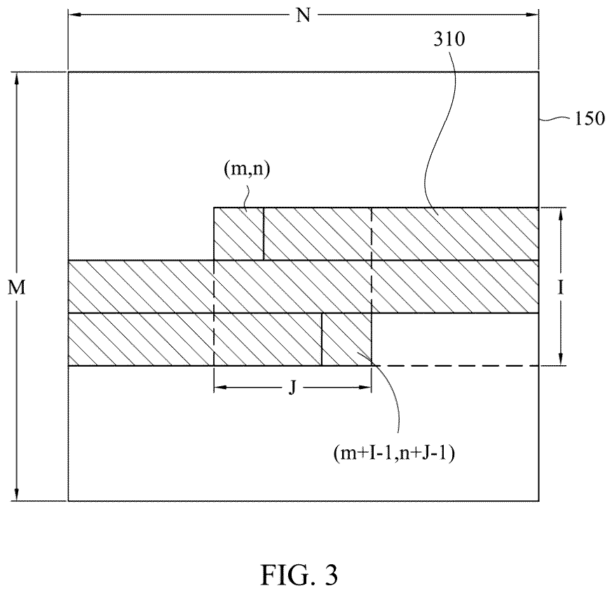

A required size of the buffer memory 130 is described as follows. FIG. 3 is a diagram illustrating sizes of the output matrix and the buffer memory in accordance with an embodiment. Referring to FIG. 3, a scenario of adopting Equation 4 is described herein for simplification. For an output element C[m,n], required calculations includes A[m,n] B[0,0], A[m,n−1] B[0,1], . . . , A[m+I−1,n+J−1]*B[I−1,J−1]. The calculation for the output element C[m,n] is done after reading the input element A[m+I−1,n+J−1]. That is, results of the multiplications have to be stored in the buffer memory 130 until the input element A[m+I−1,n+J−1] is read. Since a memory access sequence is from left to right and then from up to down, a total of ((I−1)*N)+J temporary values are needed that are equal to the number of pixels in a slashed area 310 in FIG. 3. In some embodiments, the size of the buffer memory 130 is equal to ((I−1)*N)+J which is much less than the memory size of storing the entire input matrix in the conventional art.

For each weight B[i,j] in the operation range, an index of the buffer memory 130 is calculated according to the coordinate (x,y) of the input element and the coordinate (i,j) of the corresponding weight as written in the following Equation 5.

k=(N*m+n)mod((I−1)*N+J) [Equation 5]

k is the index. “P mod Q” means the remainder of dividing P by Q. Referring to FIG. 1, the computation circuit 140 reads the temporary value 131 located at the index k which is denoted I[k] hereinafter. The product of the input element A[x,y] and the weight B[i,j] is accumulated to the temporary value I[k] as written in the following Equation 6.

I[k]+=A[x,y]*B[i,j] [Equation 6]

Next, whether accumulation times of the temporary value I[k] meet a predetermined number of times is determined, and the predetermined number of times is equal to the number of the weights in the filter. If the accumulation times do not meet the predetermined number of times, it means not all multiplications are done, and therefore the temporary value I[k] is stored back to the buffer memory 130. If the accumulation times meet the predetermined number of times, all required multiplications are already performed, and thus the temporary value I[k] is outputted. The index k and the accumulation times of the temporary value I[k] are reset. Memory space located at the index k will be used for subsequent output elements. When outputting the temporary value I[k], the bias 147 is also added to the temporary value I[k]. Next, the coordinate (m,n) may be adjusted based on the stride value 145. To be specific, whether a condition of the following Equation 7 is satisfied is determined.

stride≥2,m mod stride=0, and n mod stride=0 [Equation 7]

stride is the stride value 145. If the above condition is satisfied, the coordinate of the output element is adjusted to (p,q) where p=m/stride, q=n/stride, and a result of the adder 143 is outputted as C[p,q]. If stride=1, then the coordinate (m,n) of the output element is not modified, and the result of the adder 143 is outputted as the output element C[m,n]. If stride>1 and the condition is not satisfied, the output element is not generated.

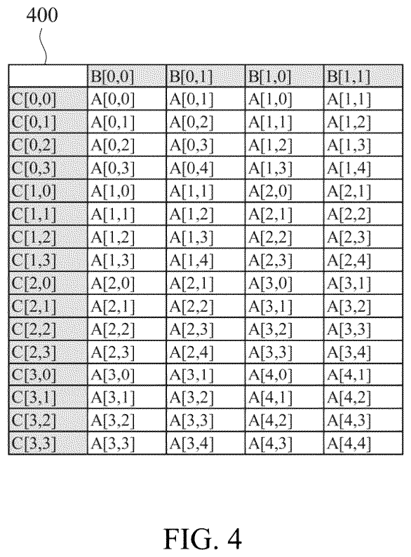

FIG. 4 is a diagram illustrating a table 400 recording multiplications of every output element. In the example of FIG. 4, the size of the input matrix A is 5×5 (i.e., X=Y=5), the size of the weight matrix B is 2×2 (i.e., I=J=2), the size of the output matrix C is 4×4 (i.e., M=N=4), the padding value P is equal to 0, the stride value is equal to 1, and the size of the buffer memory 130 is equal to 6. For example, the calculation of the output element C[0,0] is written in the following Equation 8, and so on for the other output elements.

C[0,0]=A[0,0]*B[0,0]+A[0,1]*B[0,1]+A[1,0]*B[1,0]+A[1,1]*B[1,1] [Equation 8]

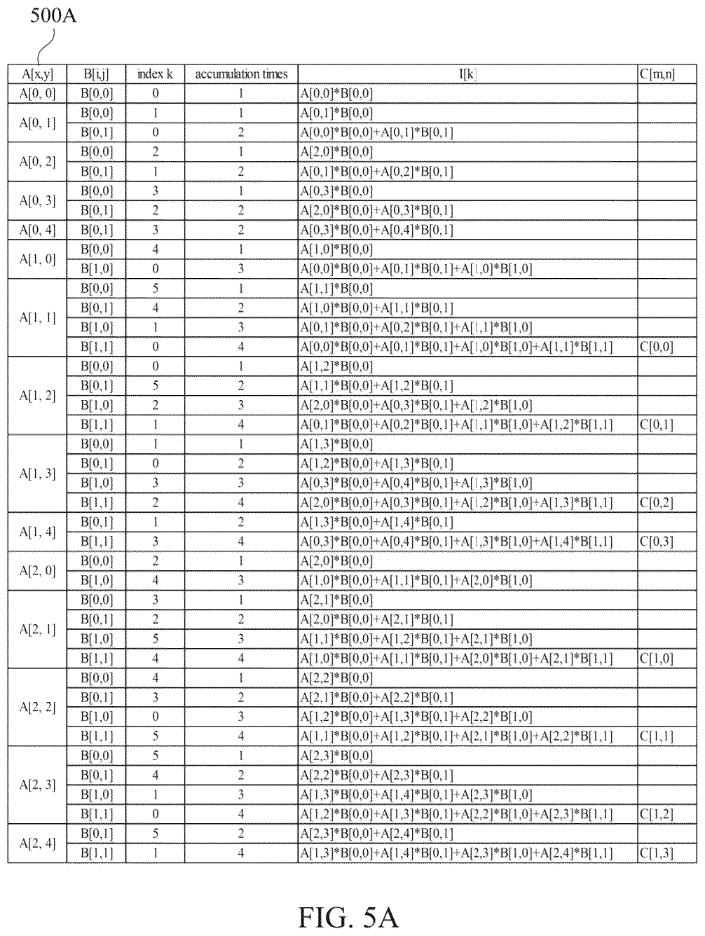

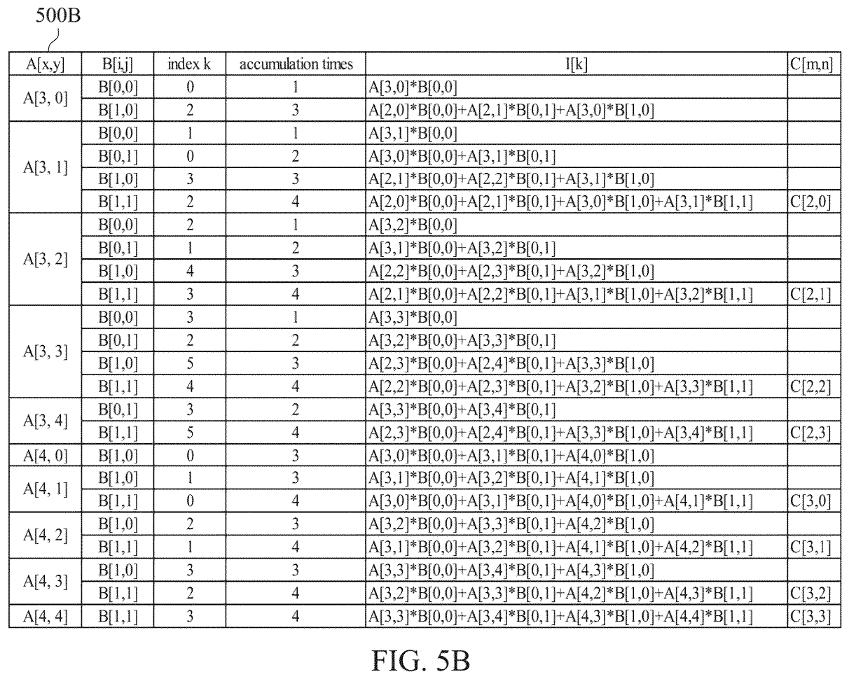

Every output element C[m,n] needs four multiplications and should be stored in the buffer memory 130 before all four multiplications are performed. FIG. 5A and FIG. 5B are diagrams illustrating tables 500A and 500B respectively in accordance with an embodiment. The tables 500A and 500B record related calculations of every input element. First, A[0,0] is inputted, then the determination of Equation 1 is performed. Only a filter location corresponding to the weight B[0,0] is within the operation range. Therefore, a product of the input element A[0,0] and the weight B[0,0] is calculated. The index k=0 is calculated according to Equation 5, and thus the product is stored in the temporary value 1[0]. Since accumulation times are less than four, no output element C[m,n] is generated. Next, the input element A[0,1] is received, and the determination of Equation 1 is performed. The filter locations corresponding to the weight B[0,0] and the weight [0,1] are within the operation range. The corresponding products are accumulated to the temporary value I[k]. Next, the input elements A[0,2] . . . A[1,0] are processed, and so on. When receiving the input element A[1,1], filter locations corresponding to the weights B[0,0], B[0,1], B[1,0], and B[1,1] are within the operation range. After the related multiplications are performed, the accumulation times of the temporary value I[0] is equal to four, and thus the temporary value I[0] is outputted as the output element C[0,0]. When the input element A[1,2] is received, the temporary value I[0] and the accumulation times thereof have been reset and can be reused. Note that the output elements are generated in a sequence of C[0,0], C[0,1], C[0,2] . . . , which is the same as the memory access sequence of the output matrix.

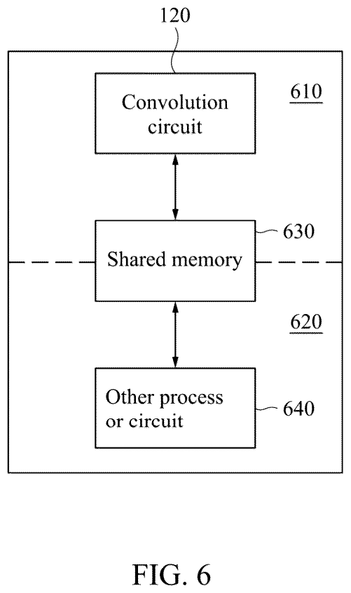

Based on the aforementioned convolution circuit, the two-dimensional input matrix is transformed into one-dimensional data. Elements of the one-dimensional data are read according to the memory access sequence. The input element will not be used after related calculation is performed and thus needs not be stored in the memory for saving memory space. In some embodiments, the convolution circuit is applied to a trust environment such as Trust Execution Environment (TEE) of ARM®. FIG. 6 is a diagram of the configuration of the convolution circuit in the trust environment in accordance with an embodiment. FIG. 6 can be viewed in terms of hardware, software or firmware architecture which is not limited in the disclosure. The system includes a trust environment 610 and a distrust environment 620, and a shared memory 630 between the environments is used to transmit data. The convolution circuit 120 is disposed in the trust environment 610, other process or circuit 640 is in the distrust environment 620. The other process or circuit 640 may be another part of the convolution neural network, any image, audio or text processing process or circuit, which is not limited in the disclosure. Is some applications, the convolution is performed in the trust environment 610 for processing sensitive data. However, the trust environment 610 is not suitable for heavy tasks such as occupying too much CPU cycles or too much memory space. When the convolution circuit 120 operates, the other process or circuit 640 stores an input element in the shared memory 630, the convolution circuit 120 receives the input element from the shared memory 630, and the convolution circuit 120 stores a computed output element in the shared memory 630. As a result, resource occupied in the trust environment 610 is reduced. The advantages of the present disclosure also include fragmenting the convolution. The convolution circuit 120 processes only one input element at a time. Therefore, time of occupation of resource is shortened and the number of times is increased, which is in line with the use characteristics of the trust environment 610.

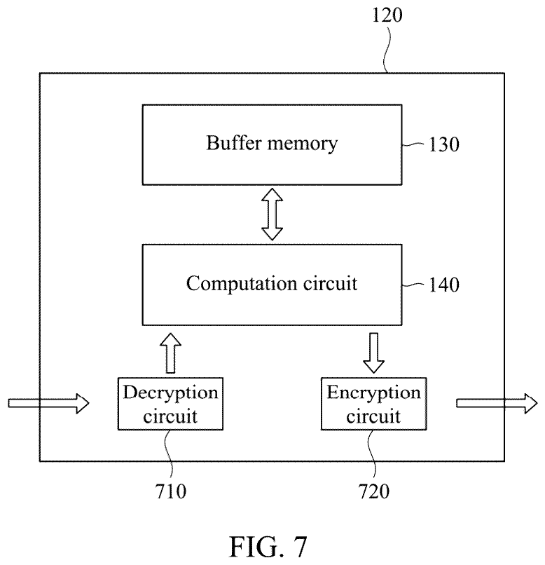

In some embodiments, the convolution circuit 120 cooperates with a decryption circuit and an encryption circuit. FIG. 7 is a diagram of the convolution circuit with functions of encryption and decryption. Referring to FIG. 7, the convolution circuit 120 includes the buffer memory 130, the computation circuit 140, a decryption circuit 710, and an encryption circuit 720. The decryption circuit 710 decrypts input data to obtain an input element which is transmitted to the computation circuit 140. The encryption circuit 720 encrypts an output element generated by the computation circuit 140. In the prior art, a two-dimensional input matrix is entirely decrypted and stored in the memory for performing the convolution, but it makes the decrypted data exposed in the memory. The input matrix is not completely decrypted in the embodiment of FIG. 7, which reduces the memory usage and avoids exposing the decrypted data.

The computation circuit 140 includes in a set of the multiplier 141, the adder 142, and the adder 143 in the embodiment of FIG. 2. However, the computation circuit 140 may include more adders and multipliers for processing multiple input elements in parallel.

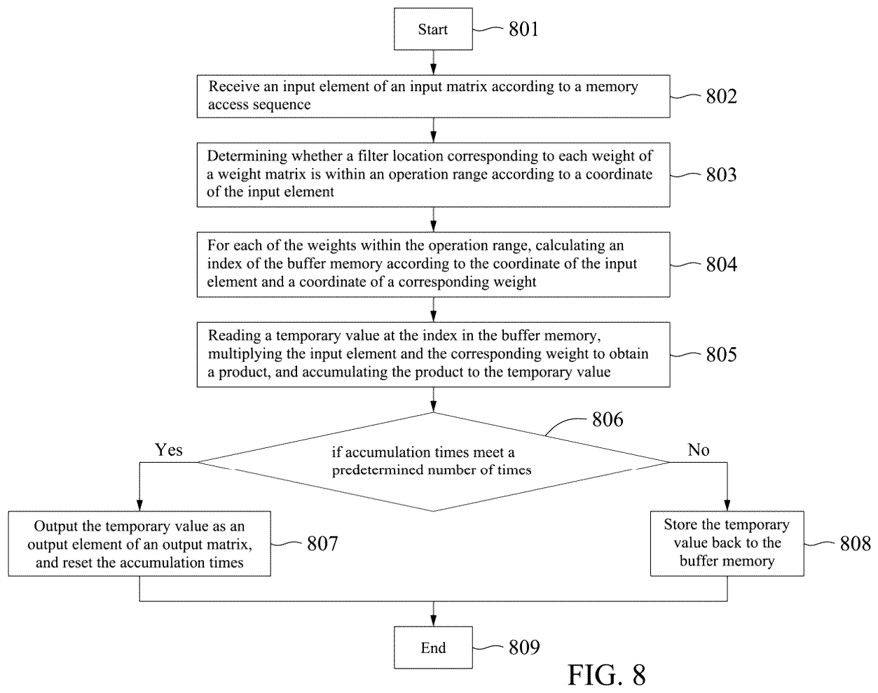

FIG. 8 is a flow chart of a convolution computation method in accordance with an embodiment. Referring to FIG. 8, the method starts in step 801. In step 802, an input element of an input matrix is received according to a memory access sequence. In step 803, it is determined whether a filter location corresponding to each weight of a weight matrix is within an operation range according to a coordinate of the input element. In step 804, for each of weights within the operation range, an index of a buffer memory is calculated according to the coordinate of the input element and a coordinate of a corresponding weight. In step 805, a temporary value at the index in the buffer memory is read, the input element and the corresponding weight are multiplied to obtain a product, and the product is accumulated to the temporary value. In step 806, whether accumulation times of the temporary value meet a predetermined number of times is determined. If the result of the step 806 is “yes”, in step 807, the temporary value is outputted as an output element of an output matrix, and the accumulation times are reset. If the result of the step 806 is “no”, in step 808, the temporary value is stored back to the buffer memory. All the steps in FIG. 8 have been described in detail above, and therefore the description will not be repeated. Note that the steps in FIG. 8 can be implemented as program codes or circuits, and the disclosure is not limited thereto. In addition, the method in FIG. 8 can be performed with the aforementioned embodiments, or can be performed independently. In other words, other steps may be inserted between the steps of FIG. 8.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A convolution circuit comprising:
a buffer memory; and
a computation circuit electrically connected to the buffer memory and configured to receive an input element of an input matrix according to a memory access sequence, wherein a plurality of weights of a weight matrix are stored in the computation circuit,
wherein the computation circuit is configured to determine whether a filter location corresponding to each of the plurality of weights is within an operation range according to a coordinate of the input element,
wherein for each of the plurality of weights within the operation range, the computation circuit is configured to calculate an index of the buffer memory according to the coordinate of the input element and a coordinate of a corresponding weight, read a temporary value at the index in the buffer memory, multiply the input element and the corresponding weight to obtain a product and accumulate the product to the temporary value,
wherein if accumulation times of the temporary value meet a predetermined number of times, the computation circuit is configured to output the temporary value as an output element of an output matrix, and reset the accumulation times,
wherein if the accumulation times do not meet the predetermined number of times, the computation circuit is configured to store the temporary value back to the buffer memory.

2. The convolution circuit of claim 1, wherein an operation of the computation circuit determining whether the filter location corresponding to each of the plurality of weights is within the operation range comprises:
subtracting the coordinate of the corresponding weight from the coordinate of the input element to determine whether the filter location is out of a first computation boundary; and
subtracting the coordinate of the corresponding weight from the coordinate of the input element plus a size of the weight matrix to determine if the filter location is out of a second computation boundary.

3. The convolution circuit of claim 2, wherein the operation range is equal to a range of the input matrix plus a padding range.

4. The convolution circuit of claim 1, wherein for each of the plurality of weights within the operation range, the computation circuit is configured to subtract the coordinate of the corresponding weight from the coordinate of the input element to obtain a coordinate of the output element.

5. The convolution circuit of claim 4, wherein the coordinate of the output element is (m,n), and the computation circuit is configured to calculate the index according to a following equation,
k=(N*m+n)mod((I−1)*N+J)
wherein k is the index, N is a column amount of the output matrix, I is a row amount of the weight matrix, J is a column amount of the weight matrix, “P mod Q” represents a remainder obtained when dividing P by Q.

6. The convolution circuit of claim 5, wherein the computation circuit is configured to determine whether a following condition is satisfied:
stride≥2,m mod stride=0, and n mod stride=0
wherein stride is a stride value,
wherein if the condition is satisfied, the computation circuit is configured to set the coordinate of the output element to be (p,q) where p=m/stride, q=n/stride.

7. The convolution circuit of claim 1, wherein the predetermined number of times is equal to a number of the plurality of weights.

8. The convolution circuit of claim 1, wherein when outputting the temporary value, the computation circuit is configured to add a bias to the temporary value.

9. The convolution circuit of claim 1, wherein the buffer memory and the computation circuit are in a trust environment, the computation circuit is configured to receive the input element through a shared memory, and store the output element in the shared memory.

10. The convolution circuit of claim 1, further comprising:
a decryption circuit configured to decrypt input data to obtain the input element; and
an encryption circuit configured to encrypt the output element.

11. A convolution computation method for a computation circuit, the convolution computation method comprising:
receiving an input element of an input matrix according to a memory access sequence;
determining whether a filter location corresponding to each of a plurality of weights of a weight matrix is within an operation range according to a coordinate of the input element;
for each of the plurality of weights within the operation range, calculating an index of a buffer memory according to the coordinate of the input element and a coordinate of a corresponding weight;
reading a temporary value at the index in the buffer memory, multiplying the input element and the corresponding weight to obtain a product, and accumulating the product to the temporary value;
if accumulation times of the temporary value meet a predetermined number of times, outputting the temporary value as an output element of an output matrix, and resetting the accumulation times; and
if the accumulation times do not meet the predetermined number of times, storing the temporary value back to the buffer memory.

12. The convolution computation method of claim 11, wherein the step of determine whether the filter location corresponding to each of the plurality of weights of the weight matrix is within the operation range comprises:
subtracting the coordinate of the corresponding weight from the coordinate of the input element to determine whether the filter location is out of a first computation boundary; and
subtracting the coordinate of the corresponding weight from the coordinate of the input element plus a size of a filter to determine if the filter location is out of a second computation boundary.

13. The convolution computation method of claim 12, wherein the operation range is equal to a range of the input matrix plus a padding range.

14. The convolution computation method of claim 11, further comprising:
for each of the plurality of weights within the operation range, subtracting the coordinate of the corresponding weight from the coordinate of the input element to obtain a coordinate of the output element.

15. The convolution computation method of claim 14, wherein the coordinate of the output element is (m,n), and the convolution computation method further comprises:
calculating the index according to a following equation:
k=(N*m+n)mod((I−1)*N+J)
wherein k is the index, N is a column amount of the output matrix, I is a row amount of the weight matrix, J is a column amount of the weight matrix, and “P mod Q” represents a remainder obtained when dividing P by Q.

16. The convolution computation method of claim 15, further comprising:
determining whether a following condition is satisfied:
stride≥2,m mod stride=0, and n mod stride=0
wherein stride is a stride value; and
if the condition is satisfied, setting the coordinate of the output element to be (p,q) where p=m/stride, q=n/stride.

17. The convolution computation method of claim 11, wherein the predetermined number of times is equal to a number of the plurality of weights.

18. The convolution computation method of claim 11, further comprising:
when outputting the temporary value, adding a bias to the temporary value.

19. The convolution computation method of claim 11, further comprising:
receiving the input element through a shared memory, and storing the output element in the shared memory.

20. The convolution computation method of claim 11, further comprising:
decrypting input data to obtain the input element; and
encrypting the output element.
